(19) United States
(12) Patent Application Publication
(10) Pub. No.: US 2021/0330543 A1
(43) Pub. Date: Oct. 28, 2021

(54) INFLATABLE MASSAGE SHOES

(71) Applicant: Guangdong Breath Walker Health Technology Co., Ltd., Dongguan City (CN)

(72) Inventors: Xingliang WU, Dongguan City (CN); Yuyuan ZHOU, Dongguan City (CN); Guoyong TANG, Dongguan City (CN)

(21) Appl. No.: 17/131,549

(22) Filed: Dec. 22, 2020

(30) Foreign Application Priority Data
Apr. 28, 2020 (CN) 202010350193.9

(51) Int. Cl. A61H 9/00; A43B 7/14; A43B 13/20; A43B 23/02

(52) U.S. Cl. CPC A61H 9/005; A43B 7/146; A43B 13/20; A43B 23/029; A61H 2205/125; A61H 2201/1642; A61H 2201/1645; A61H 2201/165; A61H 2201/0103

(57) ABSTRACT

An inflatable massage shoe includes a sole, a vamp installed on the sole, and an inflatable massage device having a main airbag and a massage airbag connected to the main airbag. The main airbag is installed on the sole and has an elastic device installed in the main airbag; the massage airbag is installed on an inner side of the vamp and communicated with the main airbag through a pipeline, and a gas in the main airbag can be exchanged with the gas in the massage airbag through the pipeline; and the vamp further includes a protective shell and an inner lining, and the massage airbag is installed between the protective shell and the inner lining. This inflatable massage shoe provides active massage actions, simulates the massage effect, and improves the comfortability, practicality, and promotion of massage shoes.

### BACKGROUND OF THE INVENTION

### Technical Field

The present invention generally relates to massage shoes, and more particularly to the inflatable massage shoes.

### Description of the Related Art

In daily life, shoes are an indispensable daily necessity. With the development of the times and technologies, our requirements for shoes are not just limited to the pure protection for our feet only, but also focus on the pursuit of the functionality of the shoes. Each part or organ of our body has a corresponding position on the foot, which is called a “foot acupoint reflection zone”, and the condition of our organ functions can be adjusted by massaging the foot acupoint reflection zones with a correct massaging technique to achieve the effects of treating, curing and preventing diseases. Therefore, the shoes with a foot massaging function become increasingly more popular with consumers.

Most of the existing massage shoes are using passive massage devices whose flexibility and comfortability are poor, and the massage device of the conventional massage shoes generally have hard magnetic massage bumps disposed inside the shoes for the purpose of massaging the feet. However, the massage device with this structure is not just too monotonous and unable to adjust the massage intensity only, but also unable to adjust the position of the massage bumps to a certain extent according to different foot types. Obviously, the conventional massage shoes are lack of flexibility, comfortability and applicability.

### SUMMARY OF THE INVENTION

Therefore, it is a primary objective of the present invention to provide a pair of inflatable massage shoes to overcome the drawbacks of the massage device of the conventional massage shoes with passive massage only and lack of flexibility and comfortability.

To achieve the aforementioned and other objectives, the present invention discloses an inflatable massage shoe comprising: a sole, a vamp installed on the sole, and an inflatable massage device; characterized in that the inflatable massage device comprises a main airbag and a massage airbag coupled to the main airbag, and the main airbag is installed on the sole and includes an elastic device installed therein; the massage airbag is installed on an inner side of the vamp and communicated with the main airbag through a pipeline, and a gas (such as air) in the main airbag can be passed through the pipeline for exchanging the gas in the massage airbag; the vamp includes a protective shell and an inner lining formed thereon, and the massage airbag is installed between the protective shell and the inner lining; when a foot presses down on the main airbag, the elastic device in the main airbag is compressed, and the gas in the main airbag is filled into the massage airbag through the pipeline, and the outer side of the massage airbag has the directional protective shell, so that the massage airbag can be expanded inwardly to squeeze and massage the foot; when the foot is lifted, the elastic device in the main airbag is popped up and reset, and the gas in the massage airbag is sucked back into the main airbag, and the massage airbag restores its flat form; while walking, the foot steps down on the ground and lifts up repeatedly to continuously massage the foot.

Further, the massage airbag has a massage area defined at the middle of an inner side thereof, and a plurality of massage bumps disposed in the massage area and provided for massing the foot.

Further, the inner lining has a massage area defined on the inner side thereof and configured to be corresponsive to the massage airbag, and the massage area has a plurality of massage bumps disposed thereon.

Further, the main airbag has a seal-edge hot embossing formed at positions other than the edge positions coupled to the massage airbag, and the seal-edge hot embossing is provided for sealing the main airbag.

The present invention further comprises an insole, and the main airbag is installed between the sole and the insole.

Further, the main airbag is installed under a heel position of the insole, and there are two massage airbags, each being installed on the inner side of the vamp and configured to be corresponsive to a recessed position under an ankle bone.

Further, the main airbag further comprises an air nozzle, two heat seal strips disposed on the air nozzle and configured to be opposite and spaced with each other, and an inlet channel formed between the two heat seal strips.

Further, the inlet channel has an air-inlet end and an air-outlet end, and the air-inlet end is disposed on an outer side of the main airbag, and the air-outlet end is disposed on an inner side of the main airbag.

Further, the air nozzle comprises an upper release film and a lower release film vertically stacked on each other, and the upper release film has an ink isolation layer disposed on an inner surface thereof, and the ink isolation layer is covered onto the air-inlet end and a part of the inlet channel on a side of the air-inlet end.

Further, the upper release film has an ink uncovered area defined on an inner surface thereof and disposed in an ink isolation layer free area at the air-outlet end of the inlet channel.

In summation, the present invention has the main airbag and the massage airbag communicated with each other, so that when the gas in the main airbag is squeezed by the sole, the gas can be filled into the massage airbag. Together with the structure of the protective shell disposed on the outer side of the massage airbag, the invention achieves the effects of providing an active massage action of the massage device, simulating the massage effect, and improving the comfortability, practicality, and promotion of the massage shoes.

### BRIEF DESCRIPTION OF THE DRAWINGS

FIG. 1 is a schematic view showing the cross-sectional structure of an inflatable massage shoe in accordance with a first embodiment of the present invention;

FIG. 2 is a schematic view showing the inflatable massage shoe as depicted in FIG. 1 in an unfolded state;

FIG. 3 is a schematic view showing a change of the inflated state of an inflatable massage device as depicted in FIG. 2;

FIG. 4 is a schematic view showing the cross-sectional structure of an inflatable massage shoe in accordance with a second embodiment of the present invention;

FIG. 5 is a schematic view showing an inflatable massage device in an unfolded state in accordance with another embodiment of the present invention;

FIG. 6 is a schematic view showing the structure of an air nozzle as depicted in FIG. 5; and

FIG. 7 is a schematic view showing the structure of an inner surface of an upper release film as depicted in FIG. 5.

### DESCRIPTION OF THE PREFERRED EMBODIMENTS

The above and other objects, features and advantages of the present invention will become apparent from the following detailed description taken with the accompanying drawings.

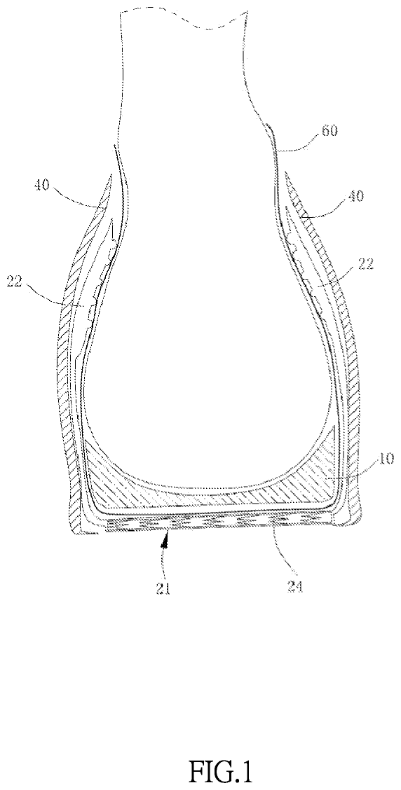

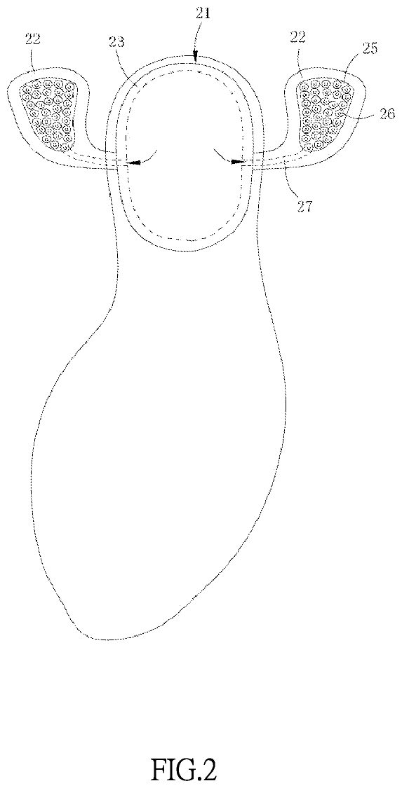

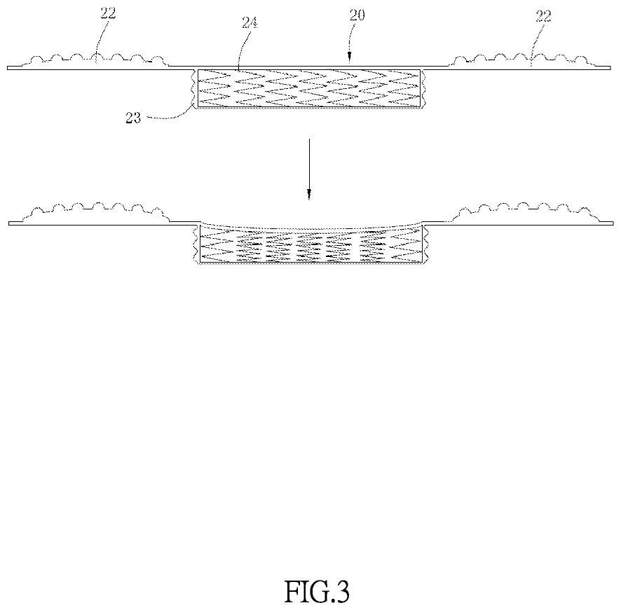

With reference to FIGS. 1 to 3 for an inflatable massage shoe of the present invention, the inflatable massage shoe comprises a sole, a vamp, an insole 10 and an inflatable massage device 20. The inflatable massage device 20 includes a main airbag 21 and a massage airbag 22 coupled to both sides of the main airbag 21 separately, and the main airbag 21 is installed between the sole and the insole 10, and the massage airbag 22 is installed on an inner side of the vamp.

The main airbag 21 has a seal-edge hot embossing 23 disposed along the edge of the main airbag 12 to ensure the airtightness of the main airbag 21. The main airbag 21 has an elastic device 24 installed therein, so that the main airbag 21 can resume its elasticity quickly after being compressed. A massage area 25 is defined at the middle of an inner side of the massage airbag 22, and the massage area 25 has a plurality of massage bumps 26 disposed therein.

The massage airbag 22 is communicated with the main airbag 21 through a pipeline 27, so that the gas contained in the main airbag 21 can enter into the massage airbag 22 through the pipeline 27. In addition, the vamp on the outer side of the massage airbag 22 has a protective shell 40, and the vamp on the inner side of the massage airbag 22 has an inner lining 60, and the massage airbag 22 is installed between the protective shell 40 and the inner lining 60. Wherein, the protective shell 40 has a relatively high hardness provided for preventing the massage airbag 22 from being expanded outwardly by forces.

In this embodiment, the main airbag 21 is installed under the insole at the heel position, and the two massage airbags 22 are installed separately at a recessed position on the vamp under the ankle bone and corresponding to the vamp. Understandably, in other embodiments, the massage airbag 22 may also be installed at any desired position, and its specific installation position is not limited.

When in use, a foot presses down on the main airbag 21, so that the elastic device 24 inside the main airbag 21 is compressed, and the gas inside the main airbag 21 is filled from both sides into the massage airbag 22 through the pipeline 27. Since the outer side of the massage airbag 22 has the directional protective shell 40, the massage airbag 22 will be expanded inwardly to squeeze the foot in a direction towards the inner lining 60, and the massage bumps 26 disposed on the massage airbag 22 will massage the foot.

When the foot is lifted, the elastic device 24 installed in the main airbag 21 will be popped up and reset, and the gas inside the massage airbag 22 will be sucked back into the main airbag 21 to restore its flat form. When walking, the foot steps down on the ground and lifts up repeatedly, so that the bumps on the massage airbag 22 continuously massage the foot to improve the comfortability of the massage.

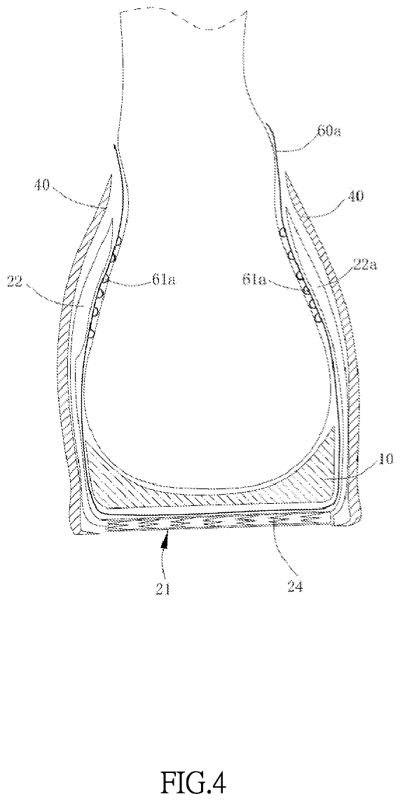

With reference to FIG. 4 for a second embodiment of the present invention, the structure of the second embodiment is substantially the same as the structure of the first embodiment, and their difference resides on that the massage bumps 61a of the second embodiment are disposed on an inner surface of the inner lining 60a, and there is no massage bmp on the massage airbag 22a. When in use, the massage airbag 22 is expanded inwardly towards the foot to squeeze the inner lining 60a, and the massage bumps 61 on the inner lining 60a will massage the foot.

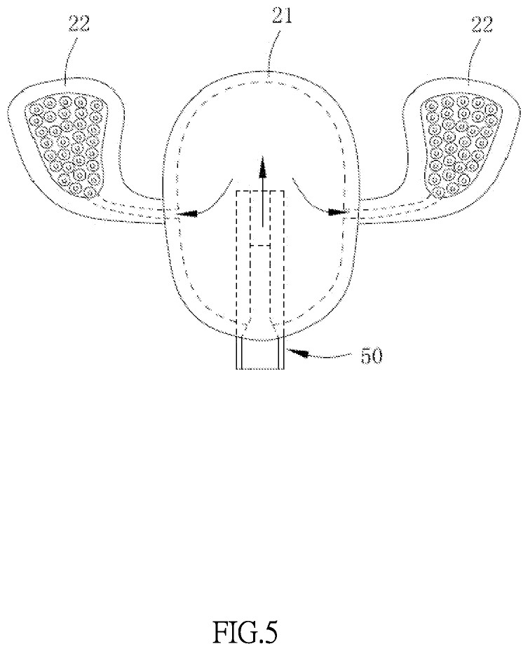

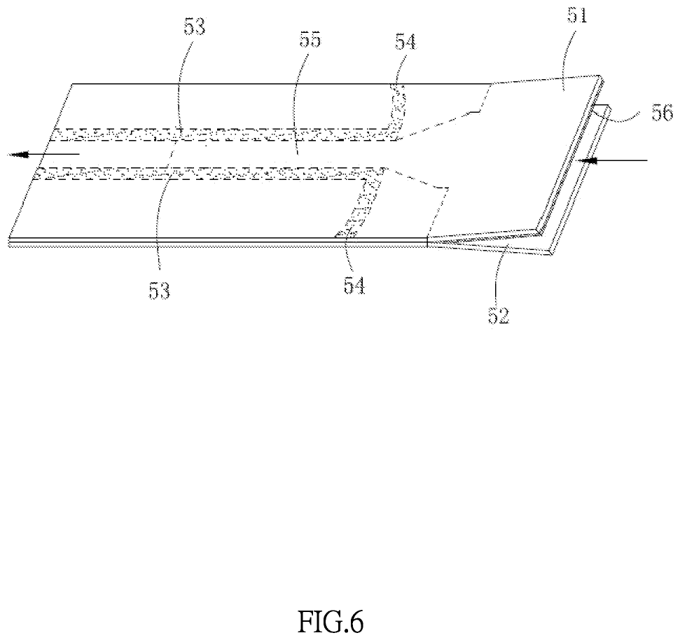

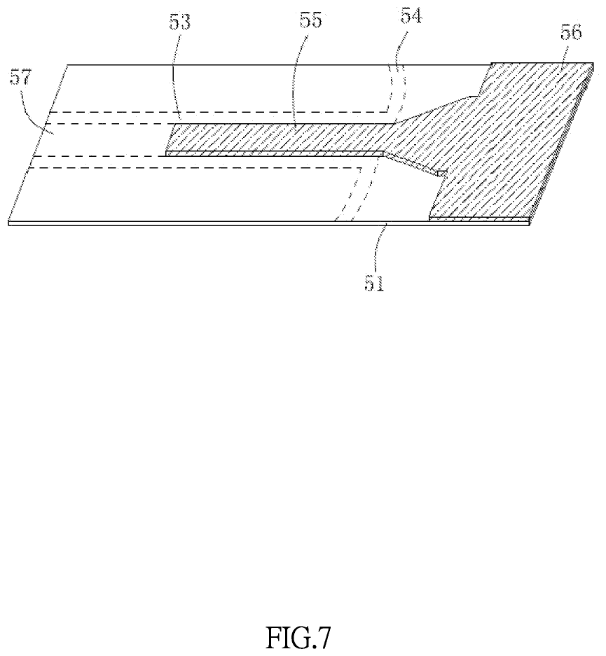

In FIGS. 5 to 7, the inflatable massage shoe further comprises the following structures: The main airbag 21 further has an air nozzle 50 communicated with the outside. The air nozzle 50 comprises an upper release film 51 and a lower release film 52, wherein the upper release film 51 and the lower release film 52 have the same shape, and both are rectangular and stacked on top of each other. The air nozzle 50 has two heat seal strips 53 and two hot-pressing fixing strips 54 symmetrically formed thereon, wherein the heat seal strip 53 is coupled to an end of the adjacent hot-pressing fixing strip 54.

An inlet channel 55 is formed between the two heat seal strips 53 and communicated with the outside and the main airbag 21, and used for inflating the main airbag 21, and the hot-pressing fixing strip 54 is used for hot-pressing, melting and fixing the air nozzle 50 with the main airbag 21. The inlet channel 55 has an air-inlet end and an air-outlet end, and the air-inlet end is disposed on an outer side of the main airbag 21, and the upper release film 51 and the lower release film 52 of the air-inlet end are two separated films. The air-outlet end is disposed on an inner side of the main airbag 21, and the width of the air-inlet end is greater than the width of the air-outlet end.

The upper release film 51 has an ink isolation layer 56 disposed on an inner surface thereof, and covered onto the air-inlet end and a part of the upper release film 51 of the inlet channel 55 on a side of the air-inlet end. The design of the ink isolation layer 56 not just can prevent the upper release film 51 and the lower release film 52 from being excessively adhered to the air-inlet end and unable to open easily, and can ensure the patency of the inlet channel 55 on a side of the air-inlet end. In addition, the upper release film 51 has an ink uncovered area 57 defined in the inlet channel 55 on a side of the air-outlet end, and the design of the ink uncovered area 57 can prevent the upper release film 51 and the lower release film 52 of the air-outlet end from being opened easily, so as to avoid leakage of the gas contained in the main airbag 21. In this embodiment, the air nozzle 50 can be extended out of the outer side of the shoe to facilitate inflating or deflating.

When in use, a required amount of gas is filled into the main airbag 21 through the air nozzle 50 as needed, and the gas enters into the massage airbag 22 through the pipeline 27. A user can adjust the amount of gas filled into the main airbag 21 according to the user's foot shape and size and using habits. After the inflation, the inflator is simply pulled out and no additional packaging is required, and the gas in the main airbag will not leak out.

For an over-inflation, an air tube is inserted into the inlet channel 55 and extended to a side of the air-outlet end, and the upper release film 51 and the lower release film 52 are separated from each other, so that the gas in the main airbag 21 will be discharged to the outside from the air tube. Until the amount of gas is discharged to the desired level, the air tube is removed, and the upper release film 51 and the lower release film 52 at the air-outlet end will be shut automatically to prevent gas from leaking.

In summation of the description above, the present invention has the main airbag 21 and the massage airbag 22 communicating with each other, and the gas in the main airbag 21 is compressed by the sole and can be filled into the massage airbag 22. Together with the structure of the protective shell 40 disposed on the outer side of the massage airbag 22, the invention achieves the effects of providing an active massage action of the massage device 40, simulating the massage effect, and improving the comfortability, practicality, and promotion of the massage shoes.

While the invention is described in some detail hereinbelow with reference to certain illustrated embodiments, it is to be understood that there is no intent to limit the invention to those embodiments. On the contrary, the aim is to cover all modifications, alternatives and equivalents falling within the spirit and scope of the invention as defined by the appended claims.

What is claimed is:

1. An inflatable massage shoe, comprising: a sole, a vamp installed on the sole, and an inflatable massage device; characterized in that the inflatable massage device comprises a main airbag and a massage airbag coupled to the main airbag, and the main airbag is installed on the sole and includes an elastic device installed therein; the massage airbag is installed on an inner side of the vamp and communicated with the main airbag through a pipeline, and a gas in the main airbag can be passed through the pipeline for exchanging the gas in the massage airbag; the vamp includes a protective shell and an inner lining formed thereon, and the massage airbag is installed between the protective shell and the inner lining; when a foot presses down on the main airbag, the elastic device in the main airbag is compressed, and the gas in the main airbag is filled into the massage airbag through the pipeline, and the outer side of the massage airbag has the directional protective shell, so that the massage airbag can be expanded inwardly to squeeze and massage the foot; when the foot is lifted, the elastic device in the main airbag is popped up and reset, and the gas in the massage airbag is sucked back into the main airbag, and the massage airbag restore its flat form; while walking, the foot steps down on the ground and lifts up repeatedly to continuously massage the foot.

2. The inflatable massage shoe as recited in claim 1, wherein the massage airbag has a massage area defined at the middle of an inner side thereof, and a plurality of massage bumps disposed in the massage area and provided for massing the foot.

3. The inflatable massage shoe as claimed in claim 1, wherein the inner lining has a massage area defined on the inner side thereof and configured to be corresponsive to the massage airbag, and the massage area has a plurality of massage bumps disposed thereon.

4. The inflatable massage shoe as recited in claim 1, wherein the main airbag has a seal-edge hot embossing formed at positions other than the edge positions coupled to the massage airbag, and the seal-edge hot embossing is provided for sealing the main airbag.

5. The inflatable massage shoe as recited in claim 1, further comprising an insole, and the main airbag being installed between the sole and the insole.

6. The inflatable massage shoe as recited in claim 5, wherein the main airbag is installed under a heel position of the insole, and there are two massage airbags, each being installed on the inner side of the vamp and configured to be corresponsive to a recessed position under an ankle bone.

7. The inflatable massage shoe as recited in claim 1, wherein the main airbag further comprises an air nozzle, two heat seal strips disposed on the air nozzle and configured to be opposite and spaced with each other, and an inlet channel formed between the two heat seal strips.

8. The inflatable massage shoe as recited in claim 7, wherein the inlet channel has an air-inlet end and an air-outlet end, and the air-inlet end is disposed on an outer side of the main airbag, and the air-outlet end is disposed on an inner side of the main airbag.

9. The inflatable massage shoe as recited in claim 8, wherein the air nozzle comprises an upper release film and a lower release film vertically stacked on each other, and the upper release film has an ink isolation layer disposed on an inner surface thereof, and the ink isolation layer is covered onto the air-inlet end and a part of the inlet channel on a side of the air-inlet end.

10. The inflatable massage shoe as recited in claim 9, wherein the upper release film has an ink uncovered area defined on an inner surface thereof and disposed in an ink isolation layer free area at the air-outlet end of the inlet channel.
